(19) United States
(12) Patent Application Publication
(10) Pub. No.: US 2020/0331463 A1
(43) Pub. Date: Oct. 22, 2020

(54) ENHANCED COLLISION MITIGATION

(71) Applicant: Ford Global Technologies, LLC, Dearborn, MI (US)

(72) Inventors: BRENDAN DIAMOND, Grosse Pointe, MI (US); ERIK J. CHRISTEN, Royal Oak, MI (US); MATTHEW JOSEPH, St. Clair Shores, MI (US); MERWYN CHERUVATHUR, Livonia, MI (US); SHEHAN HAPUTHANTHRI, Canton, MI (US)

(73) Assignee: Ford Global Technologies, LLC, Dearborn, MI (US)

(21) Appl. No.: 16/388,542

(22) Filed: Apr. 18, 2019

(51) Int. Cl. B60W 30/085; B60W 30/095; G06K 9/00

(52) U.S. Cl. CPC B60W 30/085; G06K 9/00845; B60W 30/0953

(57) ABSTRACT

A computer includes a processor and a memory, the memory storing instructions executable by the processor to determine predicted damage to a host vehicle from a predicted collision with a target vehicle, determine a physiological status of a user in the host vehicle, and actuate a component in the host vehicle based on the predicted damage and the physiological status.

### BACKGROUND

Vehicle collisions can occur at intersections, such as a stationary vehicle at an intersection and a target approaching the vehicle from behind. Vehicles typically include one or more systems to mitigate collisions. For example, a vehicle may include sensors to detect nearby targets that may be collision threats.

### BRIEF DESCRIPTION OF THE DRAWINGS

FIG. 1 is a block diagram of an example system for mitigating a collision.

FIG. 2 is a plan view of an example host vehicle and an example target vehicle.

FIG. 3 is a plan view of the example host vehicle orienting a target zone toward the example target vehicle.

FIG. 4 is a plan view of the example host vehicle orienting another target zone toward the example target vehicle.

FIG. 5 is flow diagram of an example process for mitigating a collision.

### DETAILED DESCRIPTION

A system includes a computer including a processor and a memory, the memory storing instructions executable by the processor to determine predicted damage to a host vehicle from a predicted collision with a target vehicle, determine a physiological status of a user in the host vehicle, and actuate a component in the host vehicle based on the predicted damage and the physiological status.

The instructions can further include instructions to identify a target zone on an exterior of the host vehicle based on the physiological status and the predicted damage.

The instructions can further include instructions to actuate the component to orient the target zone with respect to the target vehicle prior to the collision.

The instructions can include instructions to determine the physiological status based on at least one of bone density, cardiovascular data, or bone strength.

The instructions can include instructions to determine a physiological status of a second user and to actuate the component based on the physiological statuses of the user and the second user.

The instructions can further include instructions to determine a target zone on an exterior of the host vehicle based on the physiological statuses of the user and the second user.

The instructions can further include instructions to orient the target zone with respect to the target vehicle prior to the collision.

The instructions can further include instructions to determine the predicted damage based on at least one of a weight estimate for the host vehicle and the target vehicle, a host vehicle speed, or a target vehicle speed.

The instructions can further include instructions to actuate the component to change a yaw angle of the host vehicle to thereby rotate the host vehicle relative to the target vehicle.

The instructions can further include instructions to actuate the component based on a seating position of the user in the host vehicle.

The instructions can further include instructions to determine a target zone on an exterior of the host vehicle based on the seating position of the user in the host vehicle.

The physiological status can be based on a predicted impact force from the collision.

A method includes determining predicted damage to a host vehicle from a predicted collision with a target vehicle, determining a physiological status of a user in the host vehicle, and actuating a component in the host vehicle based on the predicted damage and the physiological status.

The method can further include identifying a target zone on an exterior of the host vehicle based on the physiological status and the predicted damage.

The method can further include actuating the component to orient the target zone with respect to the target vehicle prior to the collision.

The method can further include determining the physiological status based on at least one of bone density, cardiovascular data, or bone strength.

The method can further include determining a physiological status of a second user and actuating the component based on the physiological statuses of the user and the second user.

The method can further include determining a target zone on an exterior of the host vehicle based on the physiological statuses of the user and the second user.

The method can further include orienting the target zone with respect to the target vehicle prior to the collision.

The method can further include determining the predicted damage based on at least one of a weight estimate for the host vehicle and the target vehicle, a host vehicle speed, or a target vehicle speed.

The method can further include actuating the component to change a yaw angle of the host vehicle to thereby rotate the host vehicle relative to the target vehicle.

The method can further include actuating the component based on a seating position of the user in the host vehicle.

The method can further include determining a target zone on an exterior of the host vehicle based on the seating position of the user in the host vehicle.

A system includes a steering component in a host vehicle, means for determining predicted damage to a host vehicle from a predicted collision with a target vehicle, means for determining a physiological status of a user in the host vehicle, and means for actuating the steering component based on the predicted damage and the physiological status.

The system can further include means for identifying a target zone on an exterior of the host vehicle based on the physiological status and the predicted damage.

The system can further include actuating the steering component to orient the target zone with respect to the target vehicle prior to the collision.

The system can further include means for determining a physiological status of a second user and means for actuating the steering component based on the physiological statuses of the user and the second user.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

By determining a physiological status for each user, a vehicle computer can determine how to orient the vehicle to mitigate impact forces received by the users based on each user's ability to receive the impact forces. The computer can then identify an impact zone on an exterior of the vehicle to receive the target vehicle during the collision, the impact zone determined to reduce the impact force absorbed by users with higher physiological statuses. Thus, the collision is mitigated for users less resilient to impact forces. Based on the direction at which the target approaches the vehicle, different parts of the vehicle may absorb more of the impact force than other parts of the vehicle during a collision. Further, different users in a vehicle may receive impact forces from a target vehicle differently based on biological factors specific for each user. For example, a younger user may be more resilient and absorb the impact force more readily than an elderly user.

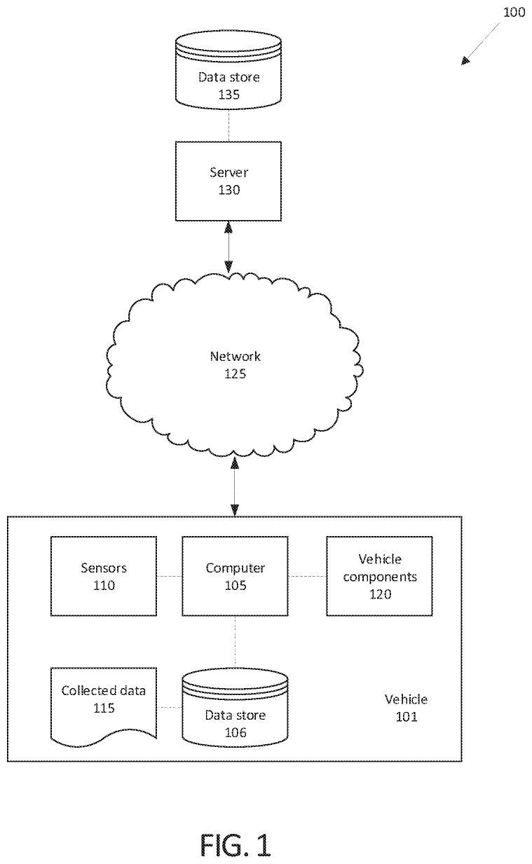

FIG. 1 illustrates an example system 100 for mitigating a vehicle collision. The system 100 includes a computer 105. The computer 105, typically included in a vehicle 101, is programmed to receive collected data 115 from one or more sensors 110. For example, vehicle 101 data 115 may include a location of the vehicle 101, data about an environment around a vehicle 101, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computer 105 is generally programmed for communications on a vehicle 101 network, e.g., including a conventional vehicle 101 communications bus. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 can be of any type, e.g., hard disk drives, solid state drives, servers, or any volatile or non-volatile media. The data store 106 can store the collected data 115 sent from the sensors 110.

Sensors 110 can include a variety of devices. For example, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a position of a component, evaluating a slope of a roadway, etc. The sensors 110 could, without limitation, also include short range radar, long range radar, LIDAR, and/or ultrasonic transducers.

Collected data 115 can include a variety of data collected in a vehicle 101. Examples of collected data 115 are provided above, and moreover, data 115 are generally collected using one or more sensors 110, and may additionally include data calculated therefrom in the computer 105, and/or at the server 130. In general, collected data 115 may include any data that may be gathered by the sensors 110 and/or computed from such data.

The vehicle 101 can include a plurality of vehicle components 120. In this context, each vehicle component 120 includes one or more hardware components adapted to perform a mechanical function or operation—such as moving the vehicle 101, slowing or stopping the vehicle 101, steering the vehicle 101, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, or the like.

When the computer 105 partially or fully operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle propulsion 140, braking, and steering are controlled by the computer 105. A semi-autonomous mode is one in which at least one of vehicle propulsion 140, braking, and steering are controlled at least partly by the computer 105 as opposed to a human operator. In a non-autonomous mode, i.e., a manual mode, the vehicle propulsion 140, braking, and steering are controlled by the human operator.

The system 100 can further include a network 125 connected to a server 130 and a data store 135. The computer 105 can further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

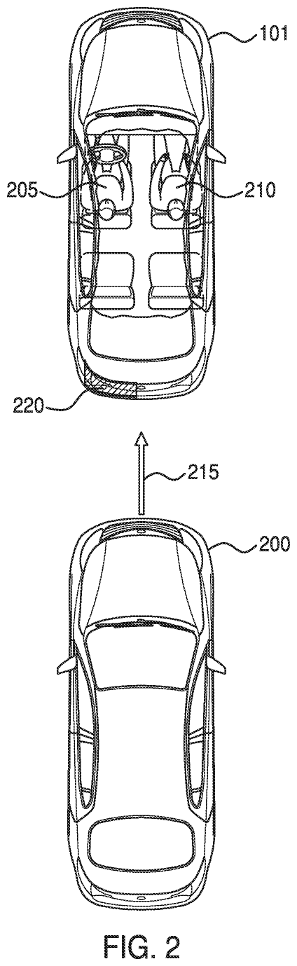

FIG. 2 shows a host vehicle 101 and a target vehicle 200 prior to a collision. FIG. 2 shows the host vehicle 101 with two users 205, 210 in front seats of the host vehicle 101. The host vehicle 101 is stationary, e.g., stopped at a traffic light. The target vehicle 200 is about to collide with the host vehicle 101, transferring an impact force to the host vehicle 101 and the users 205, 210.

The computer 105 can identify the target vehicle 200. The target vehicle 200 has a trajectory 215, i.e., a speed and heading along which the target vehicle 200 travels. The computer 105 can predict the trajectory 215 based on speed data 115 of the target vehicle 200 collected from one or more sensors 110 of the host vehicle 101. Based on the trajectory 215, the computer 105 can predict whether the target vehicle 200 will collide with the host vehicle 101. For example, the computer 105 can use a conventional collision simulation threat algorithm that receives the target vehicle 200 speed, the target vehicle 200 heading, and the host vehicle 101 position as inputs and provides a likelihood of a collision as an output, e.g., based on a predicted maximum deceleration of the target vehicle 200 and a distance between the target vehicle 200 and the host vehicle 101. When the collision algorithm determines that a collision with the target vehicle 200 is unavoidable (i.e., the target vehicle 200 cannot stop and the host vehicle 101 cannot move away from the target vehicle 200), the computer 105 can actuate one or more components 120 to mitigate the collision.

The computer 105 can predict an amount of damage to the host vehicle 101 from the collision with the target vehicle 200. The predicted damage is a measure of the force applied to the host vehicle 101 during the impact with the target vehicle 200. The computer 105 can predict the damage with a conventional collision algorithm that receives as inputs the target vehicle speed, weight, and direction of travel and outputs a predicted force applied to the host vehicle 101 and users in the host vehicle 101. For example, the algorithm can increase the predicted damage based on increasing target vehicle speed, outputting a greater predicted force applied to the host vehicle 101. Based on the predicted damage, the computer 105 can mitigate forces from the collision received by the users 205, 210.

As described above, the computer 105 can predict an impact force on the host vehicle 101 from the collision with the target vehicle 200 to predict the damage to the host vehicle 101. The impact force can be predicted based on, e.g., a host vehicle weight, a target vehicle weight, a target vehicle speed, a predicted kinetic energy transfer during the collision, etc. That is, the computer 105 can predict the impact force by collecting data 115 about the target vehicle 200, e.g., the target vehicle weight, the target vehicle speed, etc. The computer 105 can predict a kinetic energy of the target vehicle 200 KE_{tg} based on the target vehicle weight w_{tg} and the target vehicle speed v_{tg}, i.e.,

$$K {E}_{tg} = \frac{1}{2} ( \frac{{w}_{t g}}{g} ) {v}_{tg}^{2} ,$$

where g is the acceleration due to gravity. The computer 105 can predict the target vehicle weight w_{tg} by determining a size of the vehicle (e.g., a sedan, a light truck, etc.) and comparing the size of the vehicle to a lookup table stored in the server 130 and/or the data store 106 that includes an estimated weight based on the size. For example, a “sedan” input can result in a weight estimate of 1500 kilograms, and a “light truck” input can result in weight estimate of 2000 kg. The computer 105 can predict the impact force F_{impact} as a predicted transfer of kinetic energy ΔKE from the target vehicle 200 to the host vehicle 101. The transfer of kinetic energy ΔKE can be based on, e.g., the current kinetic energies of the host vehicle 101 and the target vehicle 200, the energy absorbing features of materials of the host vehicle 101, etc. The computer 105 can predict the impact force F_{impact} with a conventional vehicle collision algorithm.

The computer 105 can determine a physiological status of a user in the host vehicle 101. As used herein, a “physiological status” is a biological state of a user that can affect a user's tolerance or resilience to a collision and can be measured by a value between 0-100 that measures a biological resilience to an impact force during the collision. That is, the physiological status is a measure of a potential injury from an impact force. Low values (e.g., 0-10) indicate high resilience, i.e., the user may receive little effect from the impact force. High values (e.g., 90-100) indicate low resilience, i.e., the user may receive great effect from the impact force.

The computer 105 can collect biological data 115 from the users 205, 210, e.g., height, weight, age, heart rate, bone density, bone strength etc., to determine a physiological status of a user 205, 210. For example, an elderly user with a lower bone density than a younger user can have a higher physiological status than the younger user, and the elderly user can endure greater biological damage from the impact force than the younger user. That is, assume that the predicted damage of to the host vehicle 101 is an impact force of 800 N, the elderly user has a physiological status of 50, and the younger user has a physiological status of 25. Then, if the impact force is evenly received by the elderly user and the younger user, the elderly user may be more affected by the impact force. The computer 105 can collect the biological data 115 from one or more sensors 110. Alternatively or additionally, the computer 105 can collect the biological data 115 from the server 130.

The computer 105 can use the biological data 115 and the predicted impact force to determine the physiological status with a biometric model. The biometric model can take the biological data 115 as inputs, e.g., a height, a weight, an age, a bone density, a bone circumference, cardiovascular statuses, etc., and provide a value between 0-100 as an output. The biometric model can adjust the physiological status based on the biological data 115 and the predicted impact force. For example, the biometric model can increase the physiological status based on increasing age, decreasing height, increasing age, decreasing bone density, decreasing bone density, increasing cardiovascular conditions, and increasing predicted impact force. That is, the biometric model can weight data 115 indicating lower resilience to the impact force to increase the physiological status. For example, a younger user can be assigned a physiological status of 70 when the computer 105 predicts a 400 N impact force would be received by the younger user, and an elderly user can be assigned a physiological status of 70 when the computer 105 predicts a 150 N impact force would be received by the elderly user. The biometric model can assign the physiological status at least in part on a table that provides a physiological status based on a user age and a predicted impact force, as shown in Table 1:

TABLE 1

| | | Force | | | | |
|---|---|---|---|---|---|---|
| | | 100-199N | 200-299N | 300-399N | 400-499N | >500N |
| Age | 20-29 | 10 | 30 | 50 | 70 | 80 |
| | 30-39 | 20 | 40 | 55 | 70 | 80 |
| | 40-49 | 40 | 50 | 60 | 75 | 85 |
| | 50-59 | 60 | 65 | 70 | 80 | 90 |
| | >60 | 70 | 75 | 80 | 85 | 90 |

As another example, the computer 105 can determine the physiological status based on a combination of biometric data 115, such as shown in Equation 1:

$$P S = \frac{{( Age - 30 )}^{2}}{50} + 0 .0014 \cdot {SBP}^{2} - 0 .0337 \cdot SBP + \frac{{( Weight - 150 )}^{2}}{2200} + YF \qquad ( 1 )$$

where PS is the physiological status, Age is the age of the specific user 205, 210 in years, SBP is the systolic blood pressure of the user 205, 210 in millimeters of mercury (mmHg), Weight is the weight of the user 205, 210 in pounds, and YF is a youth factor that accounts for biological differences that can change energy absorption by children. The computer 105 can determine the age of the users 205, 210 based on, e.g., a prior input indicating the age of the users 205, 210, facial recognition to stored user profiles, estimation based on facial features, etc. The computer 105 can determine the systolic blood pressure of the users 205, 210 based on data 115 from biometric sensors 110 in, e.g., a wearable device of each user 205, 210. The computer 105 can determine the weight of the users 205, 210 from data 115 from weight sensors in each seat. The computer 105 can determine the youth factor based on prior input indicating that the user is a child, detection of a child seat, a user profile indicating that the user 205, 210 is a child, etc. Because a child can absorb energy during an impact differently than an adult of similar size and weight, the youth factor can be a fixed value that increases the physiological status to account for the different energy absorption of the child.

The computer 105 can identify a target zone 220, i.e., an area selected to receive a collision, on an exterior of the host vehicle 101. The target zone 220 is a portion of the exterior surface of the host vehicle 101 selected so that, when oriented toward the target vehicle 200, reduces the impact force absorbed by the users 205, 210 in the host vehicle 101. The computer 105 can identify the target zone 220 based on the predicted damage to the host vehicle 101. That is, the computer 105 can identify the target zone 220 as a portion of the exterior surface that has greater deformation strength and/or energy-absorbing characteristics to reduce the impact force applied to the users 205, 210. For example, the computer 105 can identify the target zone 220 as a portion of the rear bumper aligned with a vehicle pillar such that the rear bumper and the vehicle pillar absorb energy from the target vehicle 200, reducing the impact force applied to the users 205, 210. In another example, the target zone 220 can be a portion of the rear bumper farthest from the users 205, 210, such that when the target vehicle 200 impacts the target zone 220, more of the host vehicle 101 absorbs the impact before the impact force is applied to the users.

As another example, the computer 105 can determine the impact zone 220 based on the impact force and the material composition of the host vehicle 101. The host vehicle 101 can include frame members and other structural elements of different sizes and material strengths that can absorb different amounts of energy during an impact. For example, a steel pillar that has a 3 inch outer diameter and 0.5 inch thickness can absorb more energy than a 0.25 inch plastic fascia on a bumper. The computer 105 can use a conventional collision algorithm to predict an amount of energy absorbed by the structural elements of the host vehicle 101 and can assign each structural element of the host vehicle 101 to one of a predetermined number of zones, e.g., five zones. The zones can be assigned such that the lowest numbered zone can absorb the most amount of energy and the highest numbered zone can least the most amount of energy. The computer 105 can assign a severity value based on the predicted impact force for each zone. For example, if the predicted impact force is between 200-300 N, the severity value can be 3, and if the predicted impact force is above 500 N, the severity value can be 5. The computer 105 can multiply the severity value by the number of the numbered zone to determine an impact rating. For example, if the severity rating for zone 1 is 5, the impact rating for zone 1 is 5, and if the severity rating for zone 2 is 3, then the impact rating for zone 2 is 6. Thus, while zone 1 has a higher severity rating (i.e., it receives more force during the impact) than zone 2, zone 1 can absorb more energy than zone 2, so the impact rating of zone 1 is lower than the impact rating of zone 1. The computer 105 can determine the target zone 220 as the zone with the lowest impact rating.

The computer 105 can identify the target zone 220 based on the physiological status of the users 205, 210 and a seating position of the users 205, 210 in the host vehicle 101. As described above, the physiological status indicates the ability of a user to absorb the impact force from the target vehicle 200. Thus, the computer 105 can identify the target zone 220 to reduce overall absorption of the impact force by users 205, 210 with higher physiological statuses. For example, as shown in FIG. 2, the physiological status for a first user 205 in a left-hand seat may be 10, and the physiological status for a second user 210 in a right-hand seat may be 50, i.e., the second user 210 having the higher physiological status should receive less of the impact force. Thus, the computer 105 identifies the target zone 220 farther from the second user 210 than from the first user 205 such that less of the impact force is absorbed by the second user 210. The computer 105 can identify the target zone 220 based at least in part on a table that assigns portions of the exterior of the host vehicle 101 based on the physiological statuses and seating position of the users 205, 210, as shown in Table 2:

TABLE 2

| | | Seating Position | | |
|---|---|---|---|---|
| | | User 1: Left Front | User 1: Left Front | User 1: Right Front |
| | | User 2: Right Front | User 2: Left Rear | User 2: Right Rear |
| Physiological | User 1 > 50 | Center Rear Bumper | Right Rear Bumper | Left Rear Bumper |
| Status | User 2 < 50 | | | |
| | User 1 < 50 | Left Rear Bumper | Right Rear Bumper | Left Door |
| | User 2 ≥ 50 | | | |
| | User 1 ≥ 50 | Right Rear Bumper | Right Door | Left Rear Bumper |
| | User 2 < 50 | | | |
| | User 1 ≥ 50 | Center Rear Bumper | Right Rear Bumper | Left Rear Bumper |
| | User 2 ≥ 50 | | | |

In Table 2, “Left Front” refers to the left front seat of the host vehicle 101, “Left Rear” refers to the left rear seat of the host vehicle 101, “Right Front” refers to the right front seat of the host vehicle 101, and “Right Rear” refers to the right rear seat of the host vehicle 101. In the example of Table 2, the target zone 220 is determined based on whether the physiological status of the users 205, 210 exceeded a threshold, e.g., 50. The threshold can be selected, e.g., based on a median physiological status for a plurality of users. That is, the threshold can be selected such that substantially half of users 205, 210 would likely have a physiological status below the threshold and substantially half of users 205, 210 would likely have a physiological status above the threshold. Alternatively or additionally, the computer 105 can determine a second threshold, e.g., 30, such that substantially a third of users 205, 210 would likely have a physiological status below the second threshold, substantially a third of users 205, 210 would likely have a physiological status between the threshold and the second threshold, and substantially a third of users 205, 210 would likely have a physiological status above the threshold. The computer 105 can refer to a table like Table 2 with additional rows identifying target zones 220 when the physiological status of a user 205, 210 is between the threshold and the second threshold.

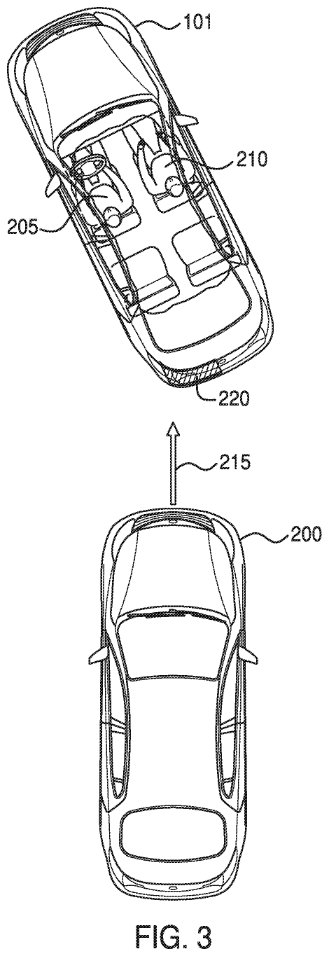

FIG. 3 shows the host vehicle 101 orienting the target zone 220 toward the target vehicle 200. Upon identifying the target zone 220, the computer 105 can actuate one or more components 120 to move the host vehicle 101 so that the target vehicle 200 impacts the target zone 220 during the collision. For example, the computer 105 can actuate a steering component 120 to change a yaw angle of the host vehicle 101 such that the portion of the rear bumper encompassing the target zone 220 is in a predicted path of travel of the target vehicle 200. The computer 105 can actuate a propulsion component 120 to achieve the change in yaw angle and then actuate a brake 120 upon reaching the change in yaw angle, orienting the target zone 220 toward the target vehicle 200. As shown in FIG. 3, the target zone 220 is oriented toward the target vehicle 200 such that the second user 210 is farther from the impact than when the host vehicle 101 was oriented forward (as shown in FIG. 2), reducing the impact force received by the second user 210.

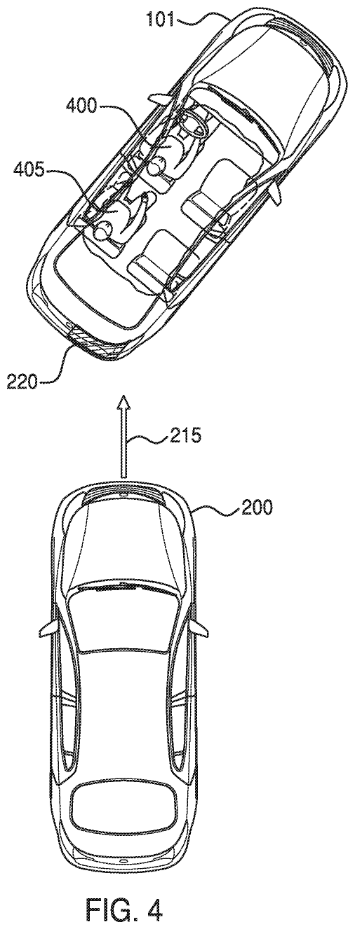

FIG. 4 shows the host vehicle 101 with users 400, 405 in different seats than in FIGS. 2-3. In the example of FIG. 4, the host vehicle 101 has a first user 400 in a front left-hand seat and a second user 405 in a rear left-hand seat. That is, the seating positions of both users 400, 405 are on the left-hand side of the host vehicle 101.

The computer 105 can identify a target zone 220. As described above, the computer 105 can, based on the seating position of the users 400, 405 and Table 2, identify the target zone 220 can be on a right-hand side of a rear bumper of the host vehicle 101 such that the impact occurs farther away from the users 400, 405 than the impact would occur if the host vehicle 101 remained in the forward direction. The computer 105 can actuate one or more components 120 to orient the target zone 220 toward the target vehicle 200 such that the target vehicle 200 collides with the target zone 220 during the collision. For example, the computer 105 can actuate the steering component 120 to change the yaw angle of the host vehicle 101 to orient the target zone 220 with respect to the target vehicle 200. Thus, the impact force of the collision received by the users 400, 405 can be reduced.

The computer 105 can identify the target zone 220 based on the physiological statuses of the users 400, 405. For example, the computer 105 can identify that the physiological status of the first user 400 is 10 and that the physiological status of the second user 405 is 50. Because the physiological status of the second user 405 is greater than the physiological status of the first user 400, the computer 105 can identify the target zone 220 such that the second user 405 is farther from the target zone 220 than the first user 400 is from the target zone 220. In the example of FIG. 4, the target zone 220 is on the right side of the rear bumper, farther from the second user 405 than the center of the rear bumper. Thus, upon impact, the second user 405 can absorb less impact force from the target vehicle 200.

As another example, the computer 105 can identify the target zone 220 based on the physiological status, the position of the users 400, 405, and the impact rating of the respective portions of the host vehicle 101 where the users 400, 405 are located. As described above, the impact rating is a measure of the severity of the collision and the ability of the structural elements of the host vehicle 101 to absorb energy from the collision. The computer 105 can multiply the physiological status of each user 400, 405 by the impact rating of the portion of the host vehicle 101 where each user 400, 405 is located to determine a predicted damage score. The predicted damage score is thus a measure of the ability of the host vehicle 101 to absorb energy from the impact and the predicted amount of damage that the user 400, 405 would receive upon receiving the impact. For example, if the first user 400 is a 40-year-old adult who weighs 185 pounds, has a systolic blood pressure of 140 mmHg, and is seated in zone 3 with a severity rating of 4, the predicted damage score of the first user 400, based on Equation 1 above, is 3×4×25=300. If the second user 405 is a 10-year-old child who weighs 50 pounds, has a systolic blood pressure of 120 mmHg, is seated in zone 3 with a severity rating of 4, and the youth factor increases the physiological status by a fixed value of 10, the predicted damage score for the second user 405 is 3×4×38=456. Thus, the computer 105 predicts that the second user 405 can experience more damage during the impact than the first user 400, and the computer 105 can identify the target zone 220 to reduce the potential damage toward the second user 405. For example, as shown in FIG. 4, the computer 105 can identify the target zone 220 to be the right rear bumper, which is farther from the second user 405 than the middle of the rear bumper.

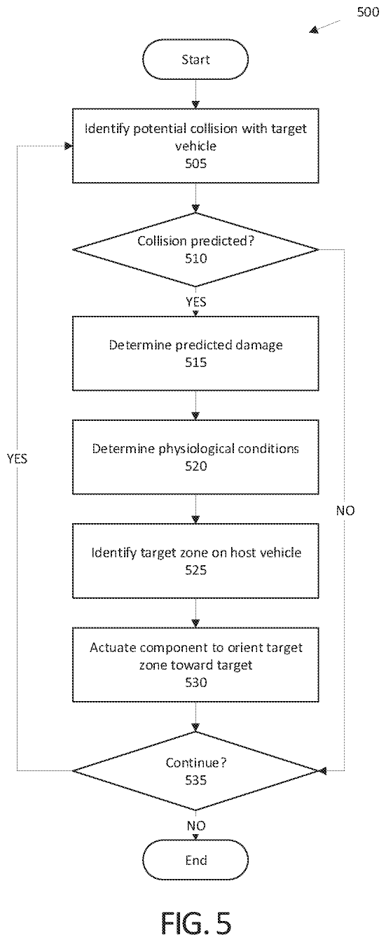

FIG. 5 is a diagram of an example process 500 for mitigating a collision between a host vehicle 101 and a target vehicle 200. The process 500 begins in a block 505, in which a computer 105 in the host vehicle 101 identifies a potential collision with the target vehicle 200. The computer 105 can actuate one or more sensors 110 to detect target vehicles 200 approaching the host vehicle 101.

Next, in a block 510, the computer 105 predicts whether a collision will occur between the host vehicle 101 and the target vehicle 200. The computer 105 can predict a speed and/or an acceleration of the target vehicle 200 and predict whether the target vehicle 200 will collide with the host vehicle 101. The computer 105 can predict the collision with, e.g., a conventional collision and/or threat assessment algorithm. If the computer 105 predicts a collision will occur, the process 500 continues in a block 515. Otherwise, the process 500 continues in a block 535.

In the block 515, the computer 105 predicts an amount of damage to the host vehicle 101. As described above, the predicted damage is a measure of the force applied to the host vehicle 101 during the impact with the target vehicle 200. The computer 105 can predict an impact force applied to the host vehicle 101 during the impact with, e.g., a conventional collision physics algorithm that receives inputs of the target vehicle 200 weight, speed, and/or acceleration and outputs the predicted impact force.

Next, in a block 520, the computer 105 determines a physiological status for each user 205, 210, 400, 405 in the host vehicle 101. As described above, the physiological status is a value measuring a user's ability to absorb a force. The computer 105 can determine the physiological status based on biometric data, e.g., size, weight, heart rate, bone density, etc. For example, the computer 105 can use the biometric model described above to assign the physiological status for each user 205, 210, 400, 405 based on the biometric data, e.g., based on the age of the users 205, 210, 400, 405 and the predicted impact force.

Next, in a block 525, the computer 105 identifies a target zone 220 on the host vehicle 101 based on the physiological statuses of the users. The target zone 220 is a portion of an exterior of the host vehicle 101 that reduces the impact force received by the users upon impact with the target vehicle 200. For example, the target zone 220 can be determined such that the target vehicle 200 impacts a vehicle pillar of the host vehicle 101, the vehicle pillar absorbing a portion of the impact force and reducing the total impact force received by the users 205, 210, 400, 405. In another example, the target zone 220 can be determined such that the predicted impact force applied to the user 205, 210, 400, 405 with the highest physiological status is reduced relative to another portion of the exterior of the host vehicle 101.

Next, in a block 530, the computer 105 actuates one or more components 120 to orient the target zone 220 toward the target vehicle 200. The computer 105 can identify a change in yaw angle of the vehicle 101 that would position the target zone 220 between the users 205, 210, 400, 405 and the target vehicle 200. The computer 105 can actuate a steering component 120 and a propulsion 120 to rotate the host vehicle 101 according to the change in yaw angle such that the target vehicle 200 is predicted to collide with the target zone 220. Upon reaching the change in yaw angle, the computer 105 can actuate a brake 120 to stop the host vehicle 101 prior to the collision with the target vehicle 200.

In the block 535, the computer 105 determines whether to continue the process 500. The computer 105 can determine to continue the process 500 when no target vehicle 200 is detected. The computer 105 can determine not to continue the process 500 when the target vehicle 200 collides with the host vehicle 101. If the computer 105 determines to continue, the process 500 continues in a block 505. Otherwise, the process 500 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices discussed herein, including the computer 105 and server 130 include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer including a processor and a memory, the memory storing instructions executable by the processor to:
determine predicted damage to a host vehicle from a predicted collision with a target vehicle;
determine a physiological status of a user in the host vehicle; and
actuate a component in the host vehicle based on the predicted damage and the physiological status.

2. The system of claim 1, wherein the instructions further include instructions to identify a target zone on an exterior of the host vehicle based on the physiological status and the predicted damage.

3. The system of claim 2, wherein the instructions further include instructions to actuate the component to orient the target zone with respect to the target vehicle prior to the collision.

4. The system of claim 1, wherein the instructions further include instructions to determine the physiological status based on at least one of bone density, cardiovascular data, or bone strength.

5. The system of claim 1, wherein the instructions further include instructions to determine a physiological status of a second user and to actuate the component based on the physiological statuses of the user and the second user.

6. The system of claim 5, wherein the instructions further include instructions to determine a target zone on an exterior of the host vehicle based on the physiological statuses of the user and the second user.

7. The system of claim 6, wherein the instructions further include instructions to orient the target zone with respect to the target vehicle prior to the collision.

8. The system of claim 1, wherein the instructions further include instructions to determine the predicted damage based on at least one of a weight estimate for the host vehicle and the target vehicle, a host vehicle speed, or a target vehicle speed.

9. The system of claim 1, wherein the instructions further include instructions to actuate the component to change a yaw angle of the host vehicle to thereby rotate the host vehicle relative to the target vehicle.

10. The system of claim 1, wherein the instructions further include instructions to actuate the component based on a seating position of the user in the host vehicle.

11. The system of claim 10, wherein the instructions further include instructions to determine a target zone on an exterior of the host vehicle based on the seating position of the user in the host vehicle.

12. The system of claim 1, wherein the physiological status is based on a predicted impact force from the collision.

13. A method, comprising:
determining predicted damage to a host vehicle from a predicted collision with a target vehicle;
determining a physiological status of a user in the host vehicle; and
actuating a component in the host vehicle based on the predicted damage and the physiological status.

14. The method of claim 13, further comprising identifying a target zone on an exterior of the host vehicle based on the physiological status and the predicted damage.

15. The method of claim 14, further comprising actuating the component to orient the target zone with respect to the target vehicle prior to the collision.

16. The method of claim 13, further comprising determining a physiological status of a second user and actuating the component based on the physiological statuses of the user and the second user.

17. A system, comprising:
a steering component in a host vehicle;
means for determining predicted damage to a host vehicle from a predicted collision with a target vehicle;
means for determining a physiological status of a user in the host vehicle; and
means for actuating the steering component based on the predicted damage and the physiological status.

18. The system of claim 17, further comprising means for identifying a target zone on an exterior of the host vehicle based on the physiological status and the predicted damage.

19. The system of claim 18, further comprising actuating the steering component to orient the target zone with respect to the target vehicle prior to the collision.

20. The system of claim 17, further comprising means for determining a physiological status of a second user and means for actuating the steering component based on the physiological statuses of the user and the second user.
